(19) United States
(12) Patent Application Publication
(10) Pub. No.: US 2024/0063600 A1
(43) Pub. Date: Feb. 22, 2024

(54) Laser System with Harmonics - Generation in the Visible and UV Spectral Range

(71) Applicant: II-VI Delaware, Inc., Wilmington, DE (US)

(72) Inventors: Valeri V. Ter-Mikirtychev, Denville, NJ (US); Nicholas Matthew Kearns, Bedminster, NJ (US); Joseph Earl Cheeney, Stanhope, NJ (US); Matthew Nicholas Kalinowski, Budd Lake, NJ (US); Jens Schumacher, Newton, NJ (US); Dominic Nicholas Loiacono, Budd Lake, NJ (US)

(21) Appl. No.: 18/234,677

(22) Filed: Aug. 16, 2023

Related U.S. Application Data
(60) Provisional application No. 63/398,379, filed on Aug. 16, 2022.

(51) Int. Cl. H01S 3/109; H01S 3/08; G02F 1/355; G02F 1/35

(52) U.S. Cl. CPC H01S 3/109; H01S 3/08086; G02F 1/3551; G02F 1/354

(57) ABSTRACT

A laser system includes one or more harmonic generator blocks or elements including one or more crystals for converting a first wavelength (λ1) laser beam into second, third and/or fourth wavelength (λ2, λ3 and/or λ4) laser beams that may be output, with or without the first wavelength (λ1) laser beam, on different beam paths. One or more of the first, second, third and/or fourth wavelength laser beams may travel or traverse in a crystal in one or multiple directions.

### CROSS-REFERENCE TO RELATED APPLICATION

This application claims the benefit of U.S. Provisional Patent Application No. 63/398,379, filed Aug. 16, 2022, the contents of which are incorporated herein by reference.

### BACKGROUND

### 1. Field

The present disclosure relates to laser systems that can generate a laser beam in the infrared (IR) spectrum, processes the IR laser beam into one or more laser beams in the visible spectrum and/or ultraviolet (UV) spectrum, and output each of the one or more laser beams in the visible spectrum and/or ultraviolet (UV) spectrum to a receiver.

### 2. Description of Related Art

One prior art laser system, disclosed in U.S. Pat. No. 10,520,790, includes a single-mode (SM) fiber laser that is configured to operate in a desired spectral range in a continuous-wave (CW) or quasi-continuous-wave (QCW) mode. The fiber laser is configured with a pump source, outputting narrow-linewidth pump light at a fundamental wavelength in desired spectral range, and a single-pass harmonic generator, such as a nonlinear lithium triborate (LBO) crystal, frequency doubling the pump light to output light at a desired signal wavelength. The pump light source has an SM seed which emits SM pump light with a linewidth narrower than 0.2 nm, and at least one ytterbium (“Yh”) fiber amplifier receiving and amplifying the SM pump light at the fundamental wavelength while maintaining the linewidth narrower than (12 nm. The SM Green fiber laser operates with an efficiency between 15% and 30% in a 510-540 nm signal wavelength range and a power range between about 50 W and kW-levels.

One drawback of the above-described prior art laser system is a linewidth of the laser source is 10-40 GHz. It would be desirable to provide a laser system having a larger or greater linewidth capable of outputting greater power than the prior art laser systems.

### SUMMARY

Disclosed herein is laser system comprising a laser source outputting a first wavelength laser beam in the infrared spectrum and a first harmonic generator block or element including a first crystal disposed or positioned for receiving from the laser source the first wavelength laser beam and for outputting from the first crystal the first wavelength laser beam and a second wavelength laser beam. The first crystal may be a LBO crystal. The crystal may be operated in a non-critically phase matching conditions, i.e., the first crystal may be cut in manner known in the art and may be operated at a temperature of about 148° C.

In an example, the laser source may comprise a laser generator for generating the first wavelength laser beam and a polarization maintaining optical fiber having a linewidth greater than or equal to 40 or 50 GHz, for conveying the first wavelength laser beam to the first crystal. The linewidth may be between 40-300 GHz inclusive or between 40-120 GHz inclusive. In an example, the laser source may generate a linearly polarized first wavelength laser beam having a spectral linewidth greater than or equal to 40 or 50 GHz and convey the first wavelength laser beam to the first crystal via the polarization maintaining optical fiber of the laser source. In an example, the laser generator may comprise additional polarization maintaining optical fiber(s).

The laser system may include a second harmonic generator block or element including a second crystal disposed or positioned for receiving from the first crystal the second wavelength laser beam and for outputting from the second crystal the second wavelength laser beam and a third wavelength laser beam, in addition to the first wavelength laser beam. The second crystal may be a lithium triborate (LBO) crystal, a barium borate (BBO) crystal or a cesium lithium borate (CLBO) crystal. Where the second crystal is an LBO crystal (like the first crystal), the specific cut of the second crystal from a boule may be different than the cut of the first crystal from a different boule depending on the desired wavelength the second crystal is to generate during use.

The laser system may include a first mirror for passing or transmitting the first wavelength laser beam output by the first crystal and for reflecting the second wavelength laser beam output by the first crystal to a second mirror which reflects the second wavelength laser beam to the second crystal. The second crystal may also be disposed or positioned for receiving from the first crystal the first wavelength laser beam and for outputting from the second crystal the first wavelength laser beam.

The laser system may include at least one of the following: the first harmonic generator block or element may include a first focusing lens in a path of the first wavelength laser beam before the first crystal; and the second harmonic generator block or element, if provided, may include a second focusing lens in a path of the first and second wavelength laser beams before the second crystal.

The laser system may include a third harmonic generator block or element including a third crystal disposed or positioned for receiving the second and third wavelength laser beams output from the second crystal and for outputting from the third crystal the second and third wavelength laser beams and a fourth wavelength laser beam. The third crystal may be a barium borate (BBO) crystal.

A prism may be disposed or positioned for receiving the second, third and fourth wavelength laser beams output by the third crystal and may separate the second, third and fourth wavelength laser beams onto different paths.

The laser system may include: a first set of mirrors disposed or positioned for passing or transmitting the first wavelength laser beam output by the second crystal and for directing the second wavelength laser beam from the second crystal to the third crystal along a first path; and a second set of mirrors disposed or positioned for directing the third wavelength laser beam from the second crystal to the third crystal along a second path. The first and second sets of mirrors may include at least one mirror in common.

The first set of mirrors may include a first mirror disposed or positioned for receiving the first, second and third wavelength laser beams from the second crystal and for passing or transmitting the first and the second wavelength laser beams; a second mirror disposed or positioned for receiving the first and the second wavelength laser beams from the first mirror, for passing or transmitting the first wavelength laser beam and for reflecting the second wavelength laser beam to a third mirror which is disposed or positioned to reflect the second wavelength laser beam to a fourth mirror which passes or transmits the second wavelength laser beam to the third crystal. The second set of mirrors may include the first mirror reflecting the third wavelength laser beam to a fifth mirror which reflects the third wavelength laser beam to a sixth mirror which reflects the third wavelength laser beam to the fourth mirror which reflects the third wavelength laser beam to the third crystal.

The laser system may include one or more of the following: a collimating lens in a path of the third wavelength laser beam between the first and fifth mirrors; a cylindrical lens in a path of the third wavelength laser beam between the fifth and sixth mirrors; a focusing lens in a path of the third wavelength laser beam between the fourth and sixth mirrors; a collimating lens in a path of the first and second wavelength laser beams between the first and second mirrors; and a focusing lens in a path of the second wavelength laser beam between the third and fourth mirrors.

The laser system may include a third harmonic generator block or element including a third crystal disposed or positioned for receiving the first wavelength laser beam output by the first crystal and the third wavelength laser beam output by the second crystal and for outputting from the third crystal the first and third wavelength laser beams and a fourth wavelength laser beam.

The first crystal may be a lithium triborate (LBO) crystal. The second crystal may be a barium borate (BBO) crystal or a cesium lithium borate (CLBO) crystal. The third crystal may be a barium borate (BBO) crystal or a cesium lithium borate (CLBO) crystal.

A prism may be disposed or positioned for receiving the first, third and fourth wavelength laser beams from the third crystal and may separate the first, third and fourth wavelength laser beams onto different paths.

The laser system may include: a first set of mirrors disposed or positioned for passing or transmitting the first wavelength laser beam output by the first crystal, for reflecting the second wavelength laser beam to the second crystal, for passing or transmitting the second wavelength laser beam output by the second crystal and for reflecting the third wavelength laser beam output by the second crystal; and a second set of mirrors disposed or positioned for reflecting the first wavelength laser beam passed or transmitted by the first set of mirrors to the third crystal, and for reflecting the third wavelength laser beam reflected by the first set of mirrors to the third crystal.

The first set of mirrors may include a first mirror for passing or transmitting the first wavelength laser beam and for reflecting the second wavelength laser beam to a second mirror which reflects the second wavelength laser beam to the second crystal which outputs the second and third wavelength laser beams to a third mirror which passes or transmits the second wavelength laser beam and which reflects the third wavelength laser beam. The second set of mirrors may include a fourth mirror for reflecting first wavelength laser beam passed or transmitted by the first mirror to a fifth mirror which passes or transmits the first wavelength laser beam to the third crystal and a sixth mirror for reflecting the third wavelength laser beam reflected by the third mirror to the fifth mirror which reflects the third wavelength laser beam to the third crystal.

The laser system may include one or more of the following: a collimating lens in a path of the first wavelength laser beam between the first and fourth mirrors; a collimating lens in a path of the second wavelength laser beam between the first and second mirrors; and a collimating lens in a path of the third wavelength laser beam between the third and sixth mirrors; the sixth mirror includes a pair of sixth mirrors and a cylindrical lens in the path of the third wavelength laser beam between the pair of a sixth mirrors; a focusing lens in a path of the first wavelength laser beam between the fourth and fifth mirrors; a focusing lens in a path of the third wavelength laser beam between the fifth and sixth mirrors; and the fourth mirror includes a pair of fourth mirrors.

The laser system may include first and second receivers disposed or positioned to receive the first and second wavelength laser beams output by the first crystal. The laser system may include first, second and third receivers disposed or positioned to receive the first, second and third wavelength laser beams output by the second crystal.

The laser system may include a first receiver disposed or positioned to receive the first wavelength laser beam output by the second crystal; and second, third and fourth receivers disposed or positioned to receive the second, third and fourth wavelength laser beams output by the third crystal.

The laser system may include a first receiver disposed or positioned to receive the first wavelength laser beam output by the first crystal; and second and third receivers disposed or positioned to receive the second and third wavelength laser beams output by the second crystal.

The laser system may include a first receiver disposed or positioned to receive the second wavelength laser beam output by the second crystal; and second, third and fourth receivers disposed or positioned to receive the first, third and fourth wavelength laser beams output by the third crystal.

The laser system may include a first mirror disposed or positioned to receive the first and second wavelength laser beams output by the first crystal in a first, forward direction and to reflect the first and second wavelength laser beams back through the first crystal in a second, reverse direction, and a second mirror disposed or positioned to receive the first and second wavelength laser beams reflected back through the first crystal in the second, reverse direction, to pass or transmit the first wavelength laser beam and to reflect the second wavelength laser beam.

The laser system may include the first harmonic generator block or element including a second crystal disposed or positioned for receiving the first and second wavelength laser beams output by the first crystal and for frequency doubling the first wavelength laser beam received by the second crystal from the first crystal, thereby increasing an energy of the second wavelength laser beam received by the second crystal from the first crystal, and for outputting from the second crystal the first wavelength laser beam and the second, energy increased, wavelength laser beam, wherein the first and second crystals are disposed or positioned whereupon the first and second wavelength laser beams output by the first crystal travel or traverse a linear path or a zig-zag path between the laser source and an input face or side of the second crystal.

The first harmonic generator block or element may include one or more dispersion optics each configured to receive a separate instance of the first and second wavelength laser beams from the first crystal and to return said separate instance of the first and second wavelength laser beams to the first crystal.

The laser system may include longitudinal axes of the first and second crystals positioned at an angle to each other and a focusing optics disposed or positioned between the first and second crystals to redirect or reflect the first and second wavelength laser beams output from the first crystal to an input face of the second crystal.

The laser system may include an intensity modulator disposed or positioned in a path of the first wavelength laser beam between the laser source and the first harmonic generator block or element. The intensity modulator may be operative or configured for intensity modulating the first wavelength laser beam received from the laser source and for providing the intensity modulated first wavelength laser beam to the first harmonic generator block or element.

### BRIEF DESCRIPTION OF THE DRAWINGS

FIG. 1 is a schematic of a non-limiting embodiment or example laser system in accordance with the principles of the present disclosure;

FIG. 2 is a schematic of another non-limiting embodiment or example laser system in accordance with the principles of the present disclosure;

FIG. 3 is a schematic of another non-limiting embodiment or example laser system in accordance with the principles of the present disclosure;

FIG. 4 is a schematic of another non-limiting embodiment or example laser system in accordance with the principles of the present disclosure;

FIG. 5 is a schematic of another non-limiting embodiment or example laser system in accordance with the principles of the present disclosure;

FIG. 6 is a schematic of another non-limiting embodiment or example laser system in accordance with the principles of the present disclosure;

FIG. 7 is a schematic of another non-limiting embodiment or example laser system in accordance with the principles of the present disclosure;

FIG. 8 is a schematic of another non-limiting embodiment or example laser system in accordance with the principles of the present disclosure;

FIG. 9A is a schematic of another non-limiting embodiment or example laser system in accordance with the principles of the present disclosure;

FIGS. 9B-9D are schematic example dispersion optics that may be used in the laser system shown in FIG. 9A;

FIG. 10A is a schematic of another non-limiting embodiment or example laser system in accordance with the principles of the present disclosure;

FIGS. 10B-10C are schematic examples of focusing optics that may be used in the laser system shown in FIG. 10A;

FIG. 11 is a schematic of an optical fiber and a heat dissipation means that may be used to transfer a laser beam of frequency λ to the heat dissipation means for dissipation of energy contained in said laser beam; and

FIGS. 12A-12B are schematic examples of intensity modulators that may be used with any of the intensity modulators disclosed in FIGS. 1-10A.

### DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure.

At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

Various non-limiting examples will now be described with reference to the accompanying figures where like reference numbers correspond to like or functionally equivalent elements.

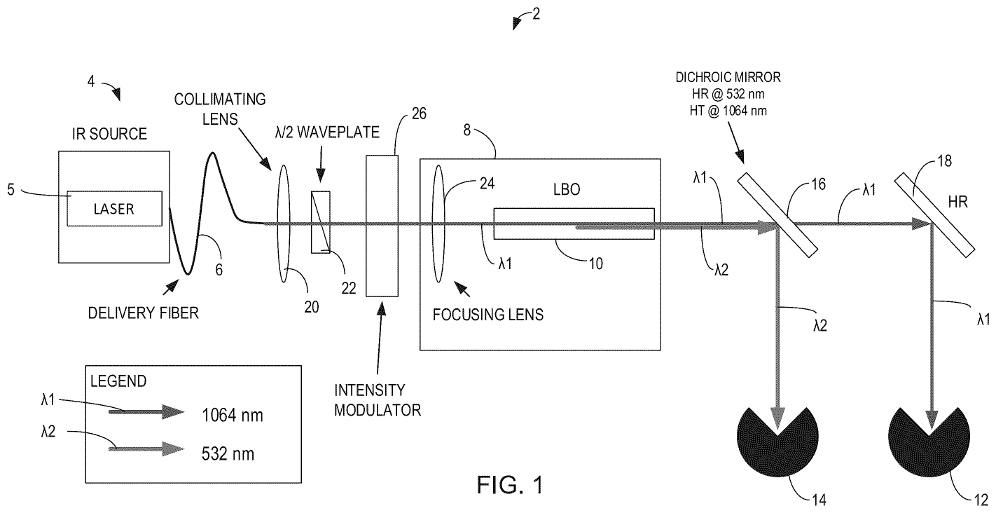

With reference to FIG. 1, a non-limiting embodiment or example laser system 2 in accordance with the principles of the present disclosure includes a laser source 4 comprising a laser generator 5 and an optical fiber 6 for delivering or conveying an IR laser beam at a first frequency (λ1) having a wavelength of, for example, without limitation, 1055 nm±35 nm, from the laser generator 5 to a first harmonic generator block or element 8. In an example, the laser generator 5 may comprise a linearly polarized fiber laser in a master oscillator power amplifier (MOPA) configuration, which may comprise, without limitation, a master oscillator, including, without limitation, a polarization-maintaining (PM) fiber-coupled laser(s) comprising one or more of the following: a distributed feedback (DFB) diode laser; a distributed Bragg reflector (DBR) diode laser; a microchip, diode-pumped single-frequency (SF) solid-state laser; a PM, single-frequency (SF) fiber laser; or a nonplanar ring oscillator (NPRO) diode-pumped, solid-state, single-frequency laser. However, this list of lasers is not to be construed in a limiting sense since it is envisioned that the laser generator may comprise any other element(s) now known or hereinafter developed that operate in the same manner as the foregoing listed lasers.

The first harmonic generator block or element 8 may include a first crystal 10, which may be, without limitation, an lithium triborate (LBO) crystal, which is operative or configured to receive and then double the frequency of the λ1 laser beam to create or generate a laser beam at a second frequency (λ2) having a second wavelength, for example, without limitation, 527.5 nm±17.5 nm (in the visible light or green spectrum), that is one-half of the wavelength of the λ1 frequency delivered to the first harmonic generator block or element 8 by the optical fiber 6. The first crystal 10 may also be operative or configured to output a laser beam having both the λ1 and the λ2 frequencies (e.g., at the 1064 nm wavelength in the IR spectrum and at the 532 nm wavelength in the visible spectrum) to respective first and second receivers 12 and 14, each of which may be operative or configured to process at least the frequency or wavelength of the laser beam received thereby.

Throughout this disclosure, the terms “first frequency”, “second frequency”, “third frequency” and “fourth frequency” laser beams may be referred to by the variables λ1, λ2, λ3 and λ4, respectively. Throughout this disclosure, these “frequency” terms and “k” variables are used to distinguish the frequencies described in each example from one another and are not intended to describe or imply any specific frequency or frequencies or any relationship between frequencies, or related wavelengths, in each example. Moreover, throughout this disclosure, the terms “first harmonic generator block or element”, “second harmonic generator block or element”, “third harmonic generator block or element”, and “fourth harmonic generator block or element” are used to distinguish the generator blocks or elements described in each example from one another and are not intended to describe or imply any specific frequency or frequencies or any relationship between frequencies, or related wavelengths, generated by the harmonic generator blocks or elements in each example.

In an example, the first receiver 12 is disposed or positioned to receive the λ1 laser beam after passage or transmission through a first mirror 16 and subsequent reflection of the λ1 laser beam by a second mirror 18. In this example, the first mirror 16 may be highly transmissive (HT) to the λ1 laser beam in the IR spectrum and may also be highly reflective (HR) of the of the λ2 laser beam in the visible spectrum. Accordingly, in this example, the λ2 laser beam output from the first crystal 10 is reflected by the first mirror 16 to the second receiver 14. The second mirror 18 may be HR of the λ1 laser beam, whereupon the λ1 laser beam received by the second mirror 18 from the first mirror 16 is reflected by the second mirror 18 to the first receiver 12.

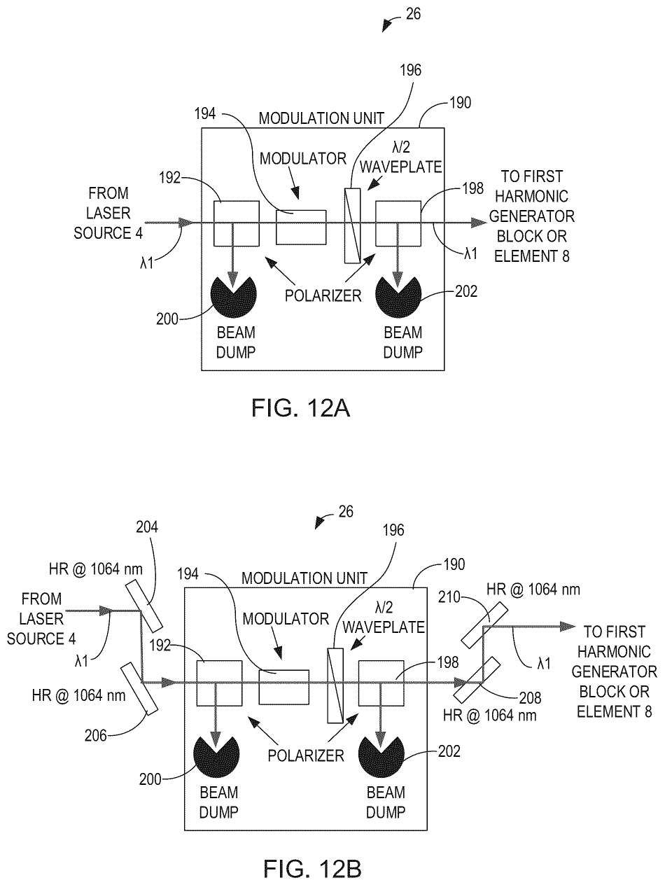

In an example, the λ1 laser beam output by the optical fiber 6 may, before reaching the first crystal 10, pass through one or more of the following: an optional collimating lens 20, an optional half (λ/2) waveplate 22, an optional intensity modulator 26 (described hereinafter with reference to FIGS. 12A-12B), and/or an optional focusing lens 24, which, in an example, may be part of the first harmonic generator block or element 8.

In some non-limiting embodiments or examples throughout this disclosure, the λ1 laser source 4 and/or laser generator 5 may:
be a quasi-continuous wave laser source with a duty cycle between 1 and 100%, where the 100% duty cycle corresponds to a continuous-wave (CW) mode; and/or
be operative or configured to output the λ1 laser beam which may have a wavelength between 1020-1090 nm; and/or
be operative or configured to output the λ1 laser beam as a linearly polarized (LP) output with a polarization extinction ratio (PER) equal to or more than 15 dB; and/or
have a spectral linewidth greater than 40 GHz or 50 GHz and/or a spectral linewidth between 40-300 GHz inclusive or between 40-120 GHz inclusive which may be achieved through either the natural linewidth of the master oscillator gain medium or through spectral broadening of the laser beam output by the master oscillator.

In some non-limiting embodiments or examples throughout this disclosure, the first crystal 10 may operate as a nonlinear optical frequency converter configured to convert the λ1 laser beam, in a single-pass, to output the λ2 laser beam (in addition to the λ1 laser beam), for example, without limitation, in the green spectral range (510-545 nm) with a diffraction-limited beam quality (M²<1.5) and/or average power from 20 watts (W) up to a 2 kW level.

In some non-limiting embodiments or examples throughout this disclosure, the optical fiber 6 may be a polarization maintaining (PM) single-mode fiber, a PM large mode area double clad fiber, or a PM large mode area triple clad fiber. In an example, the optical fiber 6 may be ytterbium (Yb)-doped or undoped. In an example, and throughout this disclosure, it is to be appreciated that features and/or characteristics of the optical fiber 6, which is used as a delivery optical fiber, may also be found in any optical fiber (not specifically shown) that may be part of the laser generator 5.

In a further example, the laser source 4 may be a linearly polarized, continuous wave Yb³⁺ doped, optical fiber design. The laser source 4 may be an optical fiber laser source that may output an infrared (IR) wavelength laser beam in 1020-1090 nm spectral range that includes a uniformly broadened spectral linewidth greater than 40 GHz or 50 GHz. The laser source 4 may have an output polarization extinction ratio of 15 dB or greater and may have a peak-to-peak intensity noise lower than 3%. The laser source 4 may include Yb-doped and undoped sections of polarization maintaining single-mode fiber or polarization maintaining large mode area double or triple clad fiber or both. The first harmonic generator block or element 8 may output laser beam(s) having a peak-to-peak intensity noise lower than 3% and output power of 20 Watts or greater.

In an example, the laser source 4 may comprise a master oscillator—power amplifier architecture, wherein, the master oscillator may be a polarization maintaining fiber coupled single-mode single frequency (SF) laser source with a 5 MHz spectral linewidth or less. In an example, the spectral linewidth of the laser source 4 may be uniformly broadened by using one or more optical fiber coupled amplitude or phase modulators between the master oscillator and the optical fiber 6.

The first crystal 10 may be an LBO crystal operating in non-critically phase matching conditions, i.e., the first crystal 10 may be cut in manner known in the art and may be operated at a temperature of about 148° C. The first crystal may have a propagation length between 2 cm and 10 cm.

In this example, the λ1 and the λ2 laser beams may have wavelengths of 1055 nm±35 nm (in the IR spectrum) and 527.5 nm±17.5 nm (in the visible, green spectrum), respectively.

Throughout this disclosure, heat generated by a laser beam in any crystal may be dissipated or removed by a surrounding housing or a beam dump heatsink or may be transferred or dumped to an external heat dissipation means or a remote beam dump heatsink via an optical fiber.

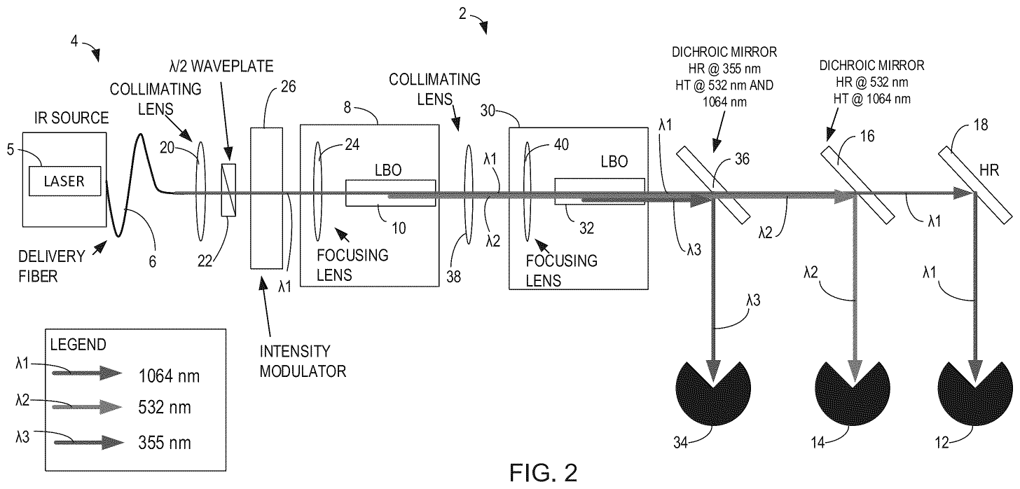

With reference to FIG. 2 and with continuing reference to FIG. 1, another non-limiting embodiment or example laser system 2 in accordance with the principles of the present disclosure may include the λ1 laser source 4 and the first harmonic generator block or element 8 arranged and/or operative as described above in connection with FIG. 1. In addition the laser system 2 shown in FIG. 2 may include a second harmonic generator block or element 30 including a second crystal 32 which may be, without limitation, a lithium triborate (LBO) crystal. The second crystal receives and combines the λ1 and the λ2 laser beams from the first crystal 10 to generate a third frequency (λ3) laser beam, and outputs the λ1, λ2 and λ3 laser beams to respective first, second and third receivers 12, 14 and 34, respectively.

Throughout this disclosure, the wavelength (xx) of a laser beam generated and output by a crystal, like crystal 10, in response to a pair of different incoming wavelength laser beams λy and λz may be determined according to the formula: 1/λx=1/λy+1/λz. Similarly, the wavelength (λx) of a laser beam generated and output by a crystal, like crystal 10, in response to a single incoming wavelength laser beam λy may be determined according to the formula: 1/λx=1/λy+1/λy.

In this example, the λ1 and the λ2 laser beams may have the same wavelengths as the λ1 and the λ2 laser beams described above in connection with FIG. 1 and the λ3 laser beam may have a wavelength of 351.66 nm±11.66 nm, i.e., in the ultraviolet spectrum. In this example, the first and second mirrors 16 and 18 may have the same HR and/or HT characteristics as the first and second mirrors 16 and 18 described above in connection with FIG. 1. Also, in this example, the third mirror 36 may be HT to the λ1 and the λ2 laser beams and may also be HR of the λ3 laser beam.

Hereinafter, it is to be understood that each mirror described herein that passes or transmits one or more wavelengths of laser beams may be HT to at least said one or more wavelengths. Similarly, each mirror described herein that reflects one or more wavelengths of laser beams may be HR to at least said one or more wavelengths. Moreover, each mirror described herein that passes or transmits a first set of one or more wavelengths of laser beams and also reflects a second set of one or more other wavelengths of laser beams may be HT to at least the first set of the one or more wavelengths of laser beams and may be HR to at least the second set of the one or more other wavelengths of laser beams.

Continuing with this example, the first receiver 12 may be disposed or positioned to receive the λ1 laser beam (e.g., 1064 nm wavelength) after passage or transmission through a third mirror 36 and the first mirror 16 and subsequent reflection of the λ1 laser beam by the second mirror 18. The second receiver 14 may be disposed or positioned to receive the λ2 laser beam (e.g., 532 nm wavelength) after passage or transmission through the third mirror 36 and reflection by the first mirror 16. Finally, the third receiver 34 may be disposed or positioned to receive the λ3 laser beam (e.g., 355 nm wavelength) after reflection by the third mirror 36.

In this example, the λ1 and the λ2 laser beams output by the first crystal 10 may, before reaching the second crystal 32, pass through an optional collimating lens 38, disposed or positioned between the first and second harmonic generator block or elements 8 and 30, and an optional focusing lens 40, which, in an example, may be part of the second harmonic generator block or element 30.

In an example, λ1 laser beam output by the optical fiber 6 may, before reaching the first crystal 10, pass through one or more of the following: an optional collimating lens 20, an optional half (λ/2) waveplate 22, an optional intensity modulator 26, and/or an optional focusing lens 24, which, in an example, may be part of the first harmonic generator block or element 8.

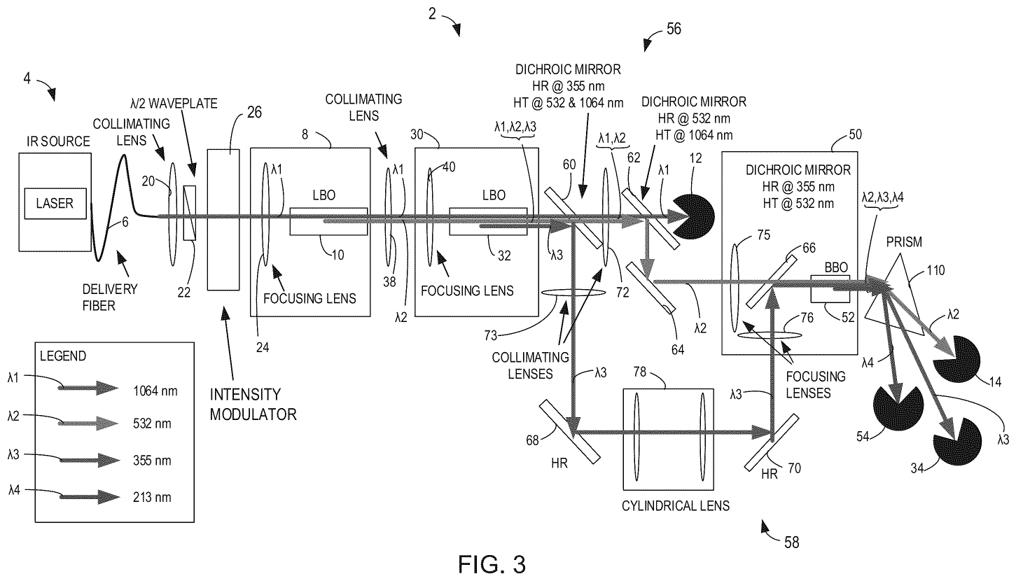

With reference to FIG. 3 and with continuing reference to FIGS. 1 and 2, another non-limiting embodiment or example laser system 2 in accordance with the principles of the present disclosure may include the laser source 4 and the first and second harmonic generator blocks or elements 8 and 30 arranged and/or operative as described above in connection with FIG. 2. In addition, the laser system 2 of FIG. 3 may include a third harmonic generator block or element 50 including a third crystal 52 which may be, without limitation, a barium borate (BBO) crystal, which receives the λ2 and the λ3 laser beams from the second crystal 32, generates therefrom a fourth frequency (λ4) laser beam, and outputs the λ2, λ3 and λ4 laser beams to respective second, third and fourth receivers 14, 34 and 54. Also in this example, the second crystal 32 outputs the λ1 laser beam to the first receiver 12 without the λ1 laser beam entering the third harmonic generator block or element 50.

In this example, the λ1, λ2, λ3 and λ4 laser beams may have wavelengths of 1055 nm±35 nm (in the IR spectrum), 527.5 nm±17.5 nm (in the visible, green spectrum), 351.66 nm±11.66 nm (in the UV spectrum), and 211 nm±7 nm (in the UV spectrum), respectively.

In an example, the laser system 2 of FIG. 3 may include a first set of mirrors 56 disposed or positioned for passing or transmitting the λ1 laser beam output by the second crystal and for reflecting the λ2 laser beam from the second crystal to the third crystal 52 along a first path. The example laser system 2 of FIG. 3 may also include a second set of mirrors 58 disposed or positioned for reflecting the λ3 laser beam from the second crystal 32 to the third crystal 52 along a second path.

In an example, the first set of mirrors 56 may include first, second, third and fourth mirrors 60, 62, 64 and 66. The first mirror 60 may be disposed or positioned for receiving the λ1, λ2 and λ3 laser beams from the second crystal 32, for passing or transmitting the λ1 and the λ2 laser beams and for reflecting the λ3 laser beam to the second set of mirrors 58. The second mirror 62 may be disposed or positioned for receiving the λ1 and the λ2 laser beams from the first mirror 60, for passing or transmitting the λ1 laser beam to the first receiver 12 and for reflecting the λ2 laser beam to the third mirror 64 which is disposed or positioned to reflect the λ2 laser beam to the fourth mirror 66, which may be part of the third harmonic generator block or element 50, which passes or transmits the λ2 laser beam to the third crystal 52.

The second set of mirrors 58 may include the first mirror 60 reflecting the λ3 laser beam to a fifth mirror 68 which reflects the λ3 laser beam to a sixth mirror 70 which reflects the λ3 laser beam to the fourth mirror 66 which reflects the λ3 laser beam to the third crystal 52.

As can be understood, the first and second sets of mirrors 56 and 58 are overlapping sets in that the first and second sets of mirrors 56 and 58 may each include the first and fourth mirrors 60 and 66 in common.

The third crystal 52 outputs the λ2 and the λ3 laser beams along with the λ4 laser beam to a prism 110. In an example, the prism 110 may be disposed or positioned for receiving the λ2, λ3 and λ4 laser beams from the third crystal 52 and is operative for separating the λ2, λ3 and λ4 laser beams onto different paths which provide the λ2, λ3 and λ4 laser beams to the respective second, third and fourth receivers 14, 34 and 54.

The laser system 2 of FIG. 3 may include an optional first collimating lens 72 in the path of the λ1 and the λ2 laser beams between the first mirror 60 and the second mirror 62. An optional second collimating lens 73 may be in the path of the λ3 laser beam between the first mirror 60 and the fifth mirror 68. An optional focusing lens 75, which may be part of the third harmonic generator block or element 50, may be in the path of the λ2 laser beam between the third mirror 64 and the fourth mirror 66. An optional focusing lens 76, which may also be part of the third harmonic generator block or element 50, may be in the path of the λ3 laser beam between the fourth mirror 66 and the sixth mirror 70. Finally, an optional cylindrical lens 78 may be in the path of the λ3 laser beam between the fifth mirror 68 and the sixth mirror 70.

In this example, the λ1 laser beam output by the optical fiber 6 may, before reaching the first crystal 10, pass through one or more of the following: an optional collimating lens 20, an optional half (λ/2) waveplate 22, an optional intensity modulator 26, and/or an optional focusing lens 24, which, in an example, may be part of the first harmonic generator block or element 8.

Also in this example, the λ1 and the λ2 laser beams output by the first crystal 10 may, before reaching the second crystal 32, pass through an optional collimating lens 38, disposed or positioned between the first and second harmonic generator blocks or elements 8 and 30, and an optional focusing lens 40, which, in an example, may be part of the second harmonic generator block or element 30.

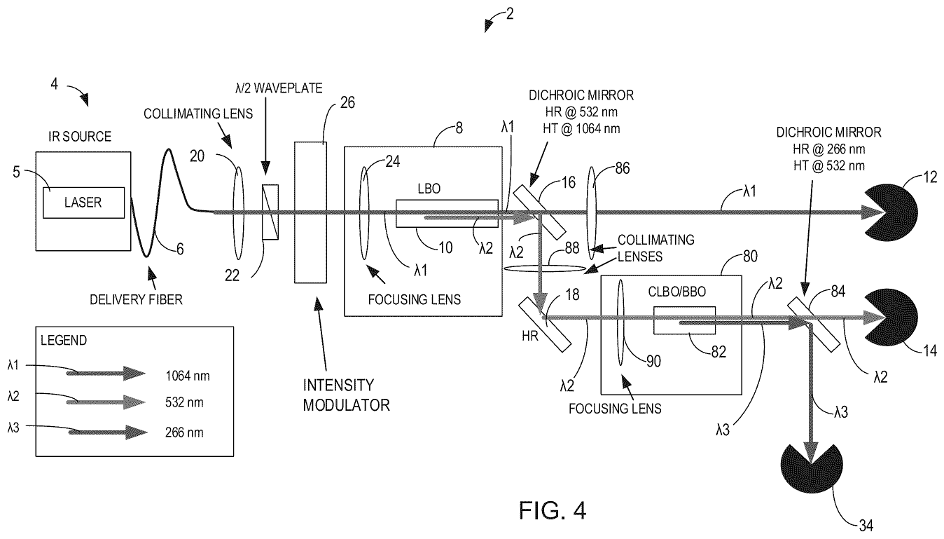

With reference to FIG. 4 and with continuing reference to FIG. 1, another non-limiting embodiment or example laser system 2 in accordance with the principles of the present disclosure may include the laser source 4 and the first harmonic generator block or element 8 arranged and/or operative as described above in connection with FIG. 1. In addition, the laser system 2 of FIG. 4 may include a second harmonic generator block or element 80 including a second crystal 82, which may be, without limitation, a barium borate (BBO) crystal or a or a cesium lithium borate (CLBO) crystal, which receives the λ2 laser beam output from the first crystal 10, generates from λ2 laser beam a third frequency (λ3) laser beam, and outputs the λ2 and the λ3 laser beams to second and third receivers 14 and 34.

In this example, the λ1, λ2 and λ3 laser beams may have wavelengths of 1055 nm±35 nm (in the IR spectrum), 527.5 nm±17.5 nm (in the visible, green spectrum), and 263.75 nm±8.75 nm (in the UV spectrum), respectively.

In an example, the laser system 2 of FIG. 4 includes a first mirror 16 for passing or transmitting the λ1 laser beam output by the first crystal 10 to the first receiver 12 and for reflecting the λ2 laser beam output by the first crystal 10 to a second mirror 18 which reflects the λ2 laser beam to the second crystal 82. The second crystal 82 outputs the λ2 and the λ3 laser beams to a third mirror 84 which passes or transmits the λ2 laser beam to the second receiver 14 and which reflects the λ3 laser beam to the third receiver 34.

The laser system 2 of FIG. 4 may include an optional first collimating lens 86 in the path of the λ1 laser beam between the first mirror 16 and the first receiver 12. An optional second collimating lens 88 may be in the path of the λ2 laser beam between the first mirror 16 and the second mirror 18. Finally, an optional focusing lens 90, which may be part of the second harmonic generator block or element 80, may be in the path of the λ2 laser beam between the second mirror 18 and the second crystal 82.

In this example, the λ1 laser beam output by the optical fiber 6 may, before reaching the first crystal 10, pass through one or more of the following: an optional collimating lens 20, an optional half (λ/2) waveplate 22, an optional intensity modulator 26, and/or an optional focusing lens 24, which, in an example, may be part of the first harmonic generator block or element 8.

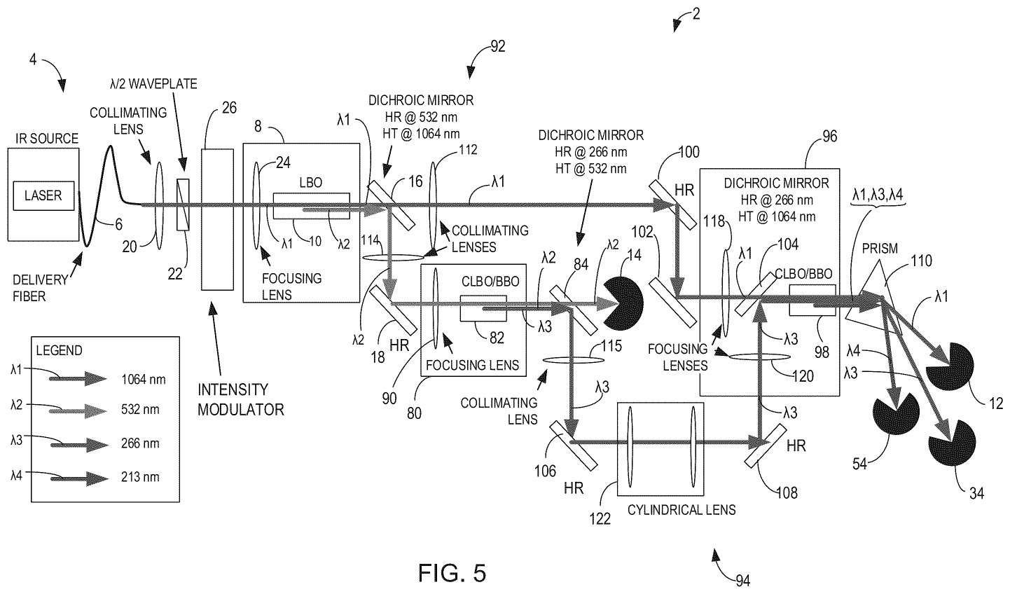

With reference to FIG. 5 and with continuing reference to FIG. 4, another non-limiting embodiment or example laser system 2 in accordance with the principles of the present disclosure may include the laser source 4, the first and second harmonic generator block or elements 8 and 80, and the mirrors 16, 18, and 84 arranged and/or operative as described above in connection with FIG. 4. In addition, the laser system 2 of FIG. 5 may include a third harmonic generator block or element 96 including a third crystal 98 which may be, without limitation, a barium borate (BBO) crystal or a cesium lithium borate (CLBO) crystal. In this example, the third crystal 98 receives the λ1 laser beam from the first crystal 10 and which receives the λ3 laser beam from the second crystal 82, generates from the λ1 and the λ3 laser beams a fourth frequency (λ4) laser beam, and outputs the λ1,λ3 and λ4 laser beams to respective first, third and fourth receivers 12, 34 and 54. Also in this example, the second crystal 82 outputs the λ2 laser beam to the second receiver 14, whereupon the λ2 laser beam does not enter the third harmonic generator block or element 96.

In this example, the λ1, λ2, λ3 and λ4 laser beams may have wavelengths of 1055 nm±35 nm (in the IR spectrum), 527.5 nm±17.5 nm (in the visible, green spectrum), 263.75 nm±8.75 nm (in the UV spectrum), and 211 nm±7 nm (in the UV spectrum), respectively.

In an example, the laser system 2 of FIG. 5 may include a first set of mirrors 92 disposed or positioned for passing or transmitting the λ1 laser beam output by the first crystal 10, for reflecting the λ2 laser beam to the second crystal 82, for passing or transmitting the λ2 laser beam output by the second crystal 82 and for reflecting the λ3 laser beam output by the second crystal. The laser system 2 of FIG. 5 may also include a second set of mirrors 94 disposed or positioned for reflecting the λ1 laser beam passed or transmitted by the first set of mirrors to the third crystal 98, and for reflecting the λ3 laser beam reflected by the first set of mirrors 92 to the third crystal.

In an example, the first set of mirrors 92 may include first, second and third mirrors 16, 18 and 84. The first mirror 16 may disposed or positioned for passing or transmitting the λ1 laser beam output by the first crystal 10 and for reflecting the λ2 laser beam output by the first crystal 10 to the second mirror 18. The second mirror 18 may disposed or positioned for reflecting the λ2 laser beam to the second crystal 82. The second crystal 82 outputs the λ2 and the λ3 laser beams to a third mirror 84 which passes or transmits the λ2 laser beam to the second receiver 14 and which reflects the λ3 laser beam to the third crystal 98 via the second set of mirrors 94.

In an example, the second set of mirrors 94 may include a pair of fourth mirrors 100 and 102, a fifth mirror 104, and a pair of sixth mirrors 106 and 108. The fourth mirror 100 may be disposed or positioned to receive the λ1 laser beam passed or transmitted by the first mirror 16 and to reflect the λ1 laser beam to the fourth mirror 102 which may be disposed or positioned to reflect the λ1 laser beam to the fifth mirror 104.

The sixth mirror 106 may be disposed or positioned to receive the λ3 laser beam reflected by the third mirror 84 and to reflect the received λ3 laser beam to the sixth mirror 108 which may be disposed or positioned to reflect the λ3 laser beam to the fifth mirror 104.

The fifth mirror 104 may be operative or configured to pass or transmit the λ1 laser beam received from the fourth mirrors 100 and 102 to the third crystal 98. The fifth mirror 104 may also be operative or configured to reflect the λ3 laser beam received from the sixth mirrors 106 and 108 to the third crystal 98.

The third crystal 98 outputs the λ1, λ3 and λ4 laser beams to a prism 110. In an example, the prism 110 may be disposed or positioned for receiving the λ1, λ3 and λ4 laser beams from the third crystal 98 and for separating the λ1, λ3 and λ4 laser beams onto different paths which provide the λ1, λ3 and λ4 laser beams to the respective first, third and fourth receivers 12, 34 and 54.

The laser system 2 of FIG. 5 may include an optional first collimating lens 112 in the path of the λ1 laser beam between the first mirror 16 and the fourth mirror 100. An optional second collimating lens 114 may be in the path of the λ2 laser beam between the first mirror 16 and the second mirror 18. An optional third collimating lens 115 may be in the path of the λ3 laser beam between the third mirror 84 and the sixth mirror 106. An optional focusing lens 90, which may be part of the second harmonic generator block or element 80, may be in the path of the λ2 laser beam between the second mirror 18 and the second crystal 82. An optional focusing lens 118, which may be part of the third harmonic generator block or element 96, may be in the path of the λ1 laser beam between the fourth mirror 102 and the fifth mirror 104. An optional focusing lens 120, which may also be part of the third harmonic generator block or element 96, may be in the path of the λ3 laser beam between the sixth mirror 108 and the fifth mirror 104. Finally, an optional cylindrical lens 122 may be in the path of the λ3 laser beam between the pair of sixth mirrors 106 and 108.

In this example, the λ1 laser beam output by the optical fiber 6 may, before reaching the first crystal 10, pass through one or more of the following: an optional collimating lens 20, an optional half (λ/2) waveplate 22, an optional intensity modulator 26 and/or an optional focusing lens 24, which, in an example, may be part of the first harmonic generator block or element 8.

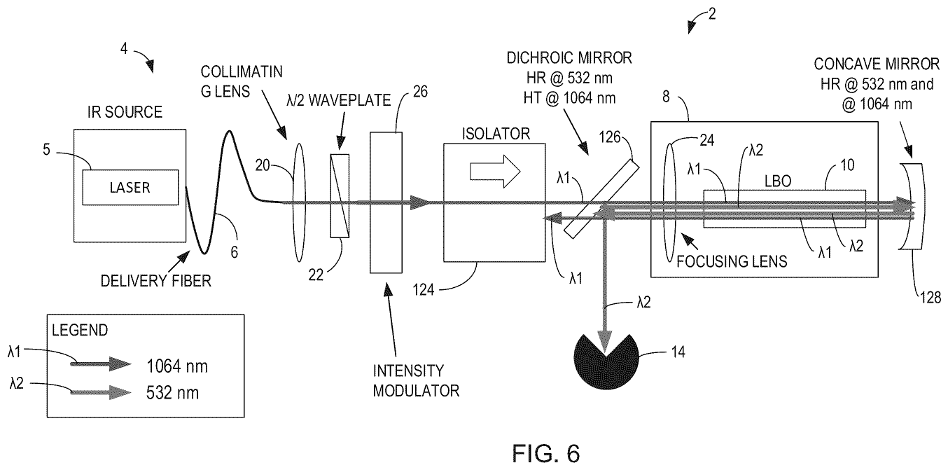

With reference to FIG. 6 and with continuing reference to FIG. 1, another non-limiting embodiment or example laser system 2 in accordance with the principles of the present disclosure may include the laser source 4 and the first harmonic generator block or element 8 arranged and/or operative as described above in connection with FIG. 1. In addition, the laser system 2 shown in FIG. 6 may include an optical isolator 124 and a mirror 126 disposed or positioned along a path of the λ1 laser beam between the laser source 4 and the crystal 10, e.g., without limitation, an LBO crystal, and a mirror 128, e.g., a concave mirror, disposed or positioned on a side of the crystal 10 opposite the mirror 126.

In this example, the λ1 and λ2 laser beams may have wavelengths of 1055 nm±35 nm (in the IR spectrum) and 527.5 nm±17.5 nm (in the visible, green spectrum), respectively.

In the laser system 2 shown in FIG. 6, the λ1 laser beam output by the laser source 4 traverses the path through the optical isolator 124 to the mirror 126 which passes or transmits the λ1 laser beam to the first crystal 10 in first, forward direction, e.g., in a longitudinal or length direction of the first crystal 10. The first crystal 10 generates from λ1 laser beam a λ2 laser beam, and outputs the λ1 and λ2 laser beams, in the first, forward direction, to the mirror 128 which reflects the λ1 and λ2 laser beams back through the first crystal 10 in second, return or reverse direction along the same path to the mirror 126. During the passage of the λ1 and λ2 laser beams back through the first crystal 10 in the second, return or reverse direction, energy continues to be transferred from the reflected λ1 laser beam to the reflected λ2 laser beam, increasing the energy of the reflected λ2 laser beam. The mirror 126 passes or transmits the reflected λ1 laser beam returned on the second, return path back to the optical isolator 124 which, in a manner known in the art, blocks (fully or partially) the reflected the λ1 laser beam. The mirror 126, however, reflects the reflected the λ2 laser beam to the second receiver 14.

The laser system 2 shown in FIG. 6 may include an optional collimating lens 20, and/or, an optional half (λ/2) waveplate 22, and/or an optional intensity modulator 26 disposed or positioned in the path of the λ1 laser beam between the laser source 4 and the optical isolator 124. An optional focusing lens 24, which may be part of the first harmonic generator block or element 8, may be disposed or positioned in a forward path of the λ1 laser beam and return paths of the λ1 and the λ2 laser beams.

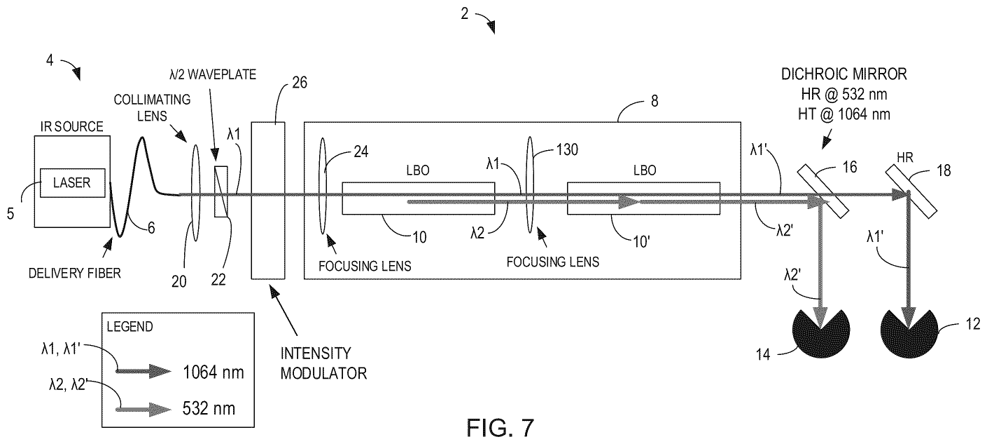

With reference to FIG. 7 and with continuing reference to FIG. 1, another non-limiting embodiment or example laser system 2 in accordance with the principles of the present disclosure may include the laser source 4, the first and second mirrors 16 and 18, and the first and second receivers 12 and 14 arranged and/or operative as described above in connection with FIG. 1. The first harmonic generator block or element 8 in this example laser system 2, however, includes a first crystal 10, which, in an example, may be an LBO crystal, and a second crystal 10′, which, in an example, may also be an LBO crystal, in series along on a linear path of the λ1 laser beam.

In this example, the λ1 and the λ2 laser beams may have wavelengths of 1055 nm±35 nm (in the IR spectrum) and 527.5 nm±17.5 nm (in the visible, green spectrum), respectively.

In the laser system 2 shown in FIG. 7, the λ1 laser beam output by the laser source 4 traverses the path to the first crystal 10 which generates from the λ1 laser beam a λ2 laser beam which the first crystal 10 outputs, along with the λ1 laser beam, to the second crystal 10′ which continues to generate and transfer energy from the λ1 laser beam energy to the λ2 laser beam, thereby increasing the energy in the λ2 laser beam entering the second crystal 10′ from the first crystal 10, and outputs λ1′ and λ2′ laser beams which correspond to the λ1 laser beam and the increased energy λ2 laser beam.

In an example, the first receiver 12 is disposed or positioned to receive the λ1′ laser beam output from the second crystal 10′ after passage or transmission through the first mirror 16 and subsequent reflection of the λ1′ laser beam by the second mirror 18. In this example, the λ2′ laser beam output from the second crystal 10′ is reflected by the first mirror 16 to the second receiver 14.

In an example, the λ1 laser beam output by the optical fiber 6 may, before reaching the first crystal 10, pass through one or more of the following: an optional collimating lens 20, an optional half (λ/2) waveplate 22, an optional intensity modulator 26 and/or an optional focusing lens 24, which, in an example, may be part of the first harmonic generator block or element 8. The first harmonic generator block or element 8 may also include an optional focusing lens 130 positioned in the path of the λ1 and the λ2 laser beams between the first and second crystal 10 and 10′.

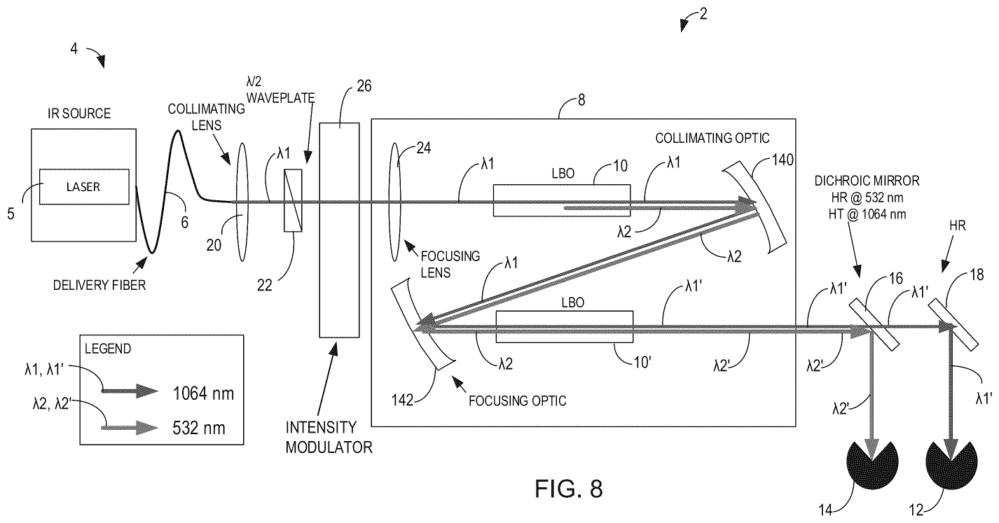

With reference to FIG. 8 and with continuing reference to FIG. 7, another non-limiting embodiment or example laser system 2 in accordance with the principles of the present disclosure may include the laser source 4, the first and second mirrors 16 and 18, and the first and second receivers 12 and 14 arranged and/or operative as described above in connection with FIG. 7. The first harmonic generator block or element 8 in this example laser system 2, however, includes a first crystal 10 and a second crystal 10′ in series along a zig-zag path of the λ1 laser beam. Herein, the term “zig-zag path” may include a path that veers alternatingly right and left (or vice versa) or back and forth.

In the laser system 2 shown in FIG. 8, the λ1 laser beam output by the laser source 4 traverses the path to the first crystal 10 which generates from the λ1 laser beam a λ2 laser beam which the first crystal 10 outputs, along with the λ1 laser beam, to the second crystal 10′ via a collimating optic or mirror 140, e.g., a concave mirror, which reflects the λ1 and the λ2 laser beams to a focusing optic(s), such as, for example, a chromatic dispersion free optic(s), or mirror 142, e.g., another concave mirror. The focusing optic or mirror 142 reflects the λ1 and the λ2 laser beams to the second crystal 10′ which generates from the λ1 laser beam energy additional λ2 energy which is added to the λ2 laser beam, thereby increasing the energy in the λ2 laser beam exiting the second crystal 10′. The second crystal 10′ outputs λ1′ and λ2′ laser beams which correspond to the λ1 laser beam and the increased energy λ2 laser beam.

In an example, the first receiver 12 is disposed or positioned to receive the λ1′ laser beam output from the second crystal 10′ after passage or transmission through the first mirror 16 and subsequent reflection of the λ1′ laser beam by the second mirror 18. In this example, the λ2′ laser beam output from the second crystal 10′ is reflected by the first mirror 16 to the second receiver 14.

In this example, the λ1, λ1′ and the λ2, λ2′ laser beams may have wavelengths of 1055 nm±35 nm (in the IR spectrum) and 527.5 nm±17.5 nm (in the visible, green spectrum), respectively.

In an example, the λ1 laser beam output by the optical fiber 6 may, before reaching the first crystal 10, pass through an optional collimating lens 20, an optional half (λ/2) waveplate 22, an optional intensity modulator 26 and/or an optional focusing lens 24, which, in an example, may be part of the first harmonic generator block or element 8.

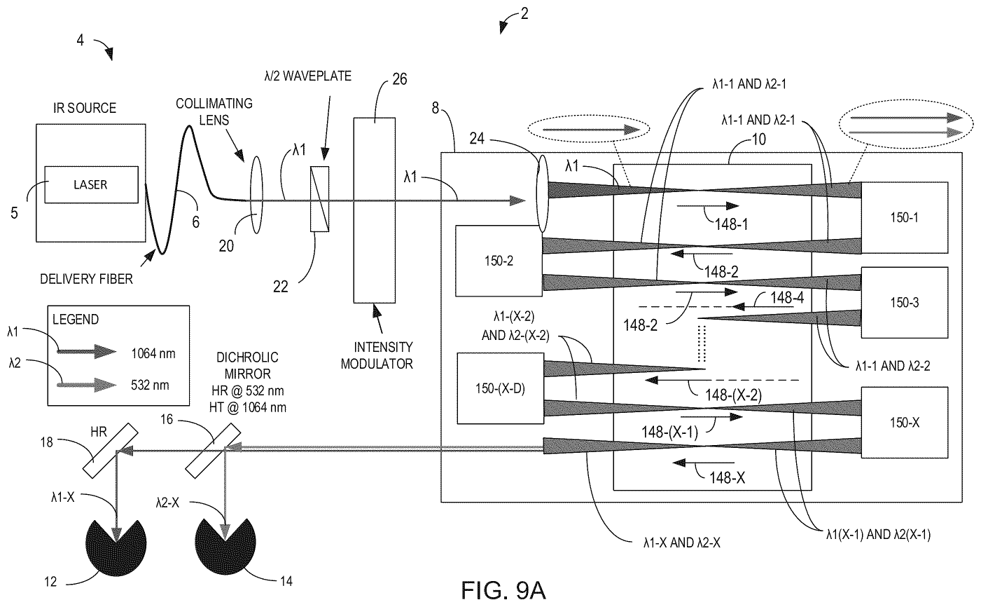

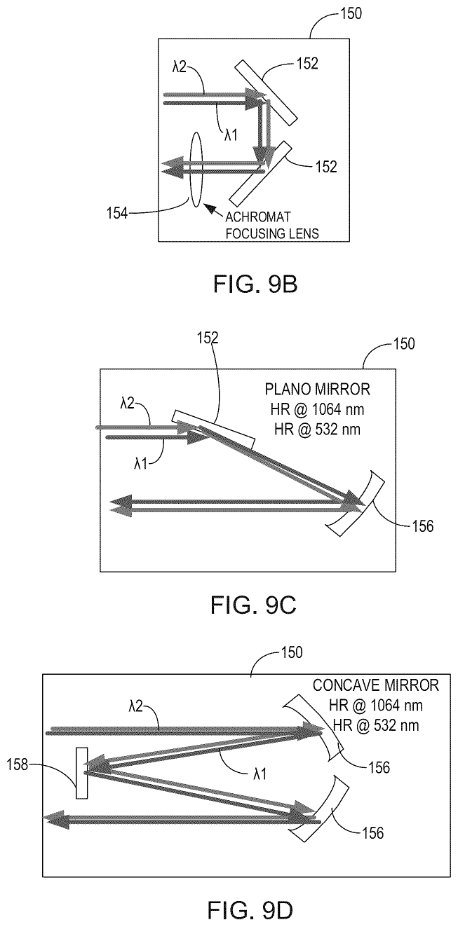

With reference to FIGS. 9A-9D and with continuing reference to FIG. 7, another non-limiting embodiment or example laser system 2 in accordance with the principles of the present disclosure may include the laser source 4, the first and second mirrors 16 and 18, and the first and second receivers 12 and 14 arranged and/or operative as described above in connection with, for example, the laser system 2 shown in FIG. 7. The first harmonic generator block or element 8 in this example laser system 2, however, includes a first crystal 10 and a number of instances of dispersion optics 150 positioned on disposed or opposite sides or ends of the first crystal 10. Each instance of the dispersion optics 150 may be operative or configured to receive an instance of the first and second laser beams from the first crystal 10 and to return said instance of the first and second laser beams to the first crystal 10. In an example, one or more or all of the dispersion optics 150 in this example may each comprise chromatic dispersion free optics which may receive incoming laser beams, reflect and refocus the received incoming laser beams, and output the reflected and refocused laser beams as described hereinafter.

In an example, in the laser system 2 shown in FIG. 9A, the λ1 laser beam output by the laser source 4 traverses the path to the first crystal 10 which doubles the frequency of the λ1 laser beam to produce the λ2 laser beam which the first crystal 10 outputs, along with the λ1 laser beam, to a first dispersion optics 150-1 along a first path 148-1. The first dispersion optics 150-1 reflects and refocuses the λ1 and the λ2 laser beams back through the first crystal 10, along a second path 148-2, which increases the energy in the λ2 laser beam, thereby producing λ1-1 and λ2-1 laser beams which are output by the first crystal 10 to a second dispersion optics 150-2. The second dispersion optics 150-2 reflects and refocuses the λ1-1 and the λ2-1 laser beams back through the first crystal 10, along a third path 148-3, which again increases the energy in the λ2-1 laser beam, thereby producing, λ1-2 and λ2-2 laser beams which are output by the first crystal 10 to a third dispersion optics 150-3.

In this example, each of the λ1, λ1-1, λ1-2, etc. laser beams and each of the λ2, λ2-1, λ2-2, etc. laser beams may have wavelengths of 1055 nm±35 nm (in the IR spectrum) and 527.5 nm±17.5 nm (in the visible, green spectrum), respectively.

The process of the third dispersion optics 150-3 and the subsequent instances of dispersion optics 150-(1-X) and 150-X receiving the λ1-2 and λ2-2 laser beams, the λ1-(X-2) and λ2-(X-2) laser beams, and the λ1-(X-1) and λ2-(X-1) laser beams, respectively, from the crystal 10 along one path and reflecting and refocusing the same back through the first crystal 10 along another path (e.g., along the fourth path 148-4 associated with the third dispersion optics 150-3), thereby increasing the energy in the respective λ2-2, λ2-(X-2) and λ2-(X-1) laser beams, up to a limit that may be determined by the design of the laser system, continues until the λ1-X and λ2-X laser beams are output from the first crystal 10 to the first and second receivers 12 and 14. In the example shown in FIG. 9A and described above, dispersion optics 150 between dispersion optics 150-3 and 150-(X-1) are omitted for simplicity, the various first and second wavelength laser beams acted upon by the omitted dispersion optics 150 are omitted for simplicity, and the paths between paths 148-4 and 148(X-2) are also omitted for simplicity.

As can be understood, each instance of dispersion optics 150 receives a separate or unique instance of the first and second wavelength laser beams, e.g., dispersion optics 150-1 receives the λ1 and the λ2 laser beams; dispersion optics 150-2 receives the λ1-1 and the λ2-2 laser beams, etc.) from the first crystal 10, and returns said instance of the first and second wavelength laser beam to the first crystal.

As would be appreciated, each time an instance of the first and second wavelength laser beams pass or traverse through the crystal 10, energy is transferred, up to a limit that may be determined by the design of the laser system, from the λ1 laser beam to the λ2 laser beam.

In the example of FIG. 9A, the first harmonic generator block or element 8 includes five instances of dispersion optics 150. However, this is not to be construed in a limiting sense since it is envisioned that the first harmonic generator block or element 8 may include any number of one, two, three, four or more dispersion optics 150 between the laser source 4 and the first and second receivers 12 and 14 as may be deemed suitable and/or desirable.

Any instance of the dispersion optics 150 in FIG. 9A may be any one of the example dispersion optics 150 shown in FIGS. 9B-9D. For example, any instance of the dispersion optics 150 in FIG. 9A may include two plano mirrors 152 disposed, positioned and/or oriented as shown in FIG. 9B for receiving and reflecting the first and second wavelength laser beams to the crystal 10. In FIG. 9B, a focusing lens 154, e.g., without limitation, a chromatic dispersion free focusing lens such as, for example, an achromat focusing lens, may be disposed or positioned to focus the first and second wavelength laser beams output by the two plano mirrors 152 before output to the crystal 10. In another example, any instance of the dispersion optics 150 in FIG. 9A may include one reflective plano mirror 152 and one concave mirror 156 disposed, positioned and/or oriented as shown in FIG. 9C for receiving and reflecting the first and second wavelength laser beams to the crystal 10. Finally, in another example, any instance of the dispersion optics 150 in FIG. 9A may include two concave mirrors 156 and an intermediate plano mirror 158 disposed, positioned and/or oriented in the path of the first and second wavelength laser beams between the two concave mirrors 156 as shown in FIG. 9D for receiving and reflecting the first and second wavelength laser beams to the crystal 10. The dispersion optics 150-1-150-X shown in FIG. 9A may include any combination of the dispersion optics 150 shown in FIGS. 9B-9D. The angle of reflection of each laser beam by each concave mirror 156 in FIGS. 9C and 9D may be optimized to minimize astigmatism of the reflected laser beam.

In an example, the λ1 laser beam output by the optical fiber 6 may, before reaching the first crystal 10, pass through one or more of the following: an optional collimating lens 20, an optional half (λ/2) waveplate 22, an optional intensity modulator 26, and/or an optional focusing lens 24, which, in an example, may be part of the first harmonic generator block or element 8.

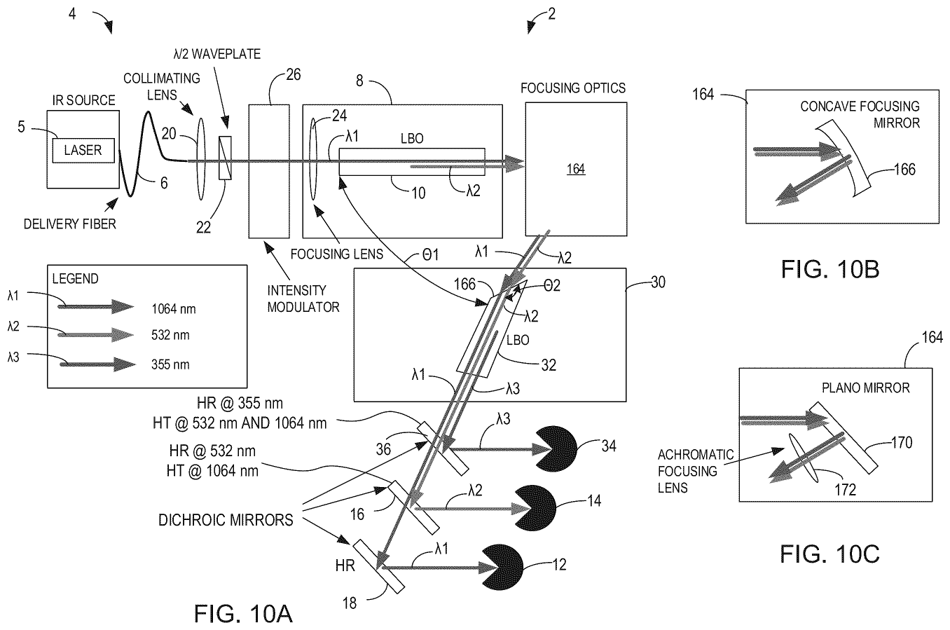

With reference to FIGS. 10A-10C and with continuing reference to FIG. 2, another non-limiting embodiment or example laser system 2 in accordance with the principles of the present disclosure may include the laser source 4 and the first harmonic generator block or element 8 arranged and/or operative as described above in connection with FIG. 2. The laser system 2 shown in FIG. 10A may also include a second harmonic generator block or element 30 including a second crystal 32 which, in an example, may be an LBO crystal. In this example, the crystals 10 and 32 of the first and second first harmonic generator blocks or elements 8 and 30 may have their longitudinal axes disposed or positioned at an angle θ1 to each other. In an example, angle θ1 may be an acute angle. However, this is not to be construed in a limiting sense since it is envisioned that angle θ1 may be an obtuse angle or right angle. The choice of angle θ1 being an acute, obtuse or right angle may be determined by one skilled in the art for a particular application.

A focusing optics 164, e.g., chromatic dispersion free optics, may be disposed or positioned in the path of the λ1 and the λ2 laser beams between the first and second crystals 10 and 32. The focusing optics 164 may comprise any suitable and/or desirable means for redirecting or reflecting the propagation direction of the λ1 and the λ2 laser beams output by the first crystal 10 to a input face 166 of the second crystal 32 which may be cut at an obtuse angle θ2 to a longitudinal axis of the second crystal 32. However, this cut angle is not to be construed in a limiting sense since it is envisioned that angle θ2 may be an obtuse angle or right angle. The choice of angle θ2 being an acute, obtuse or right angle may be determined by one skilled in the art for a particular application.

In an example, angle θ1 may be selected to minimize astigmatism of the reflected the λ1 and λ2 laser beams. In an example, angle θ2 may be selected to allow walk-off free propagation of the λ1 and λ2 laser beams inside of the second crystal 32. A person skilled in the art understands how to determine angles θ1 and θ2.

In an example, the focusing optics 164 may, as shown in FIG. 10B, comprise a concave mirror. However, this is not to be construed in a limiting sense since it is envisioned that the focusing optics 164 may, as shown in FIG. 10C, comprise other types or styles of mirrors such as, without limitation, a plano mirror 170 along with a focusing lens 172 on an output side of the plano mirror 170.

In the laser system 2 shown in FIG. 10A, the λ1 laser beam output by the laser source 4 traverses the path to the first crystal 10 which doubles the frequency of the λ1 laser beam to produce the λ2 laser beam which the first crystal 10 outputs, along with the λ1 laser beam, to the focusing optics 164 which redirects or reflects the λ1 and the λ2 laser beams to the face 166 of the second crystal 32 along a different path. The second crystal 32 receives the λ1 and the λ2 laser beams from the first crystal 10, generates a third frequency (λ3) laser beam, and outputs the λ1, λ2 and λ3 laser beams to first, second and third receivers 12, 14 and 34, respectively.

In this example, the λ1, λ2 and λ3 laser beams may have wavelengths of 1055 nm±35 nm (in the IR spectrum), 527.5 nm±17.5 nm (in the visible, green spectrum), and 351.66 nm±11.66 nm (in the UV spectrum), respectively.

In an example, the first receiver 12 is disposed or positioned to receive the λ1 laser beam output from the second crystal 32 after passage or transmission through the third mirror 36 and the first mirror 16 and subsequent reflection of the λ1 laser beam by the second mirror 18. In this example, the λ2 laser beam output from the second crystal 32 is reflected by the first mirror 16 to the second receiver 14 after passage or transmission of the λ2 laser beam through the third mirror 36. Finally, in this example, the λ3 laser beam output by from the second crystal 10 is reflected by the third mirror 36 to the third receiver 34.

In an example, the λ1 laser beam output by the optical fiber 6 may, before reaching the first crystal 10, pass through one or more of the following: an optional collimating lens 20, an optional half (λ/2) waveplate 22, an optional intensity modulator 26 and an optional focusing lens 24, which, in an example, may be part of the first harmonic generator block or element 8.

Any one or more of the receivers 12, 14, 34 and/or 54 described herein may be configured or operative to perform any suitable and/or desirable function such as, for example, for further propagation of a received laser beam to downstream optics or electronics and/or as a power meter to measure the power of the received laser beam. In another example, any one or more of the receivers 12, 14, 34 and/or 54 described herein may be configured or operative as a beam block to block further propagation of a received laser beam. In another example, any one or more of the receivers 12, 14, 34 and/or 54 described herein may be omitted entirely, whereupon its laser beam k may be output into free-space.

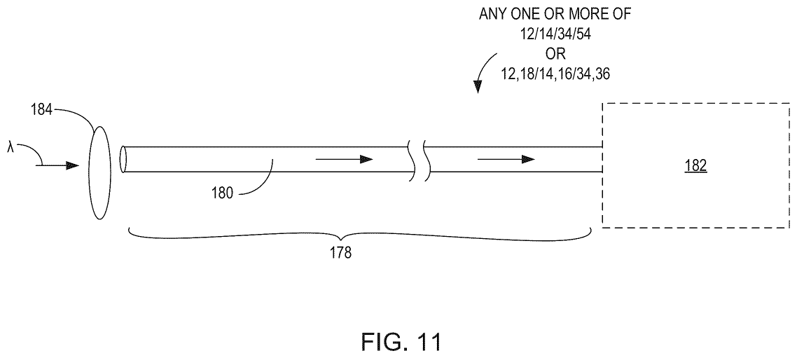

With reference to FIG. 11, also or alternatively, any one or more of the receivers 12, 14, 34 and/or 54 described throughout this disclosure may be replaced by a fiber coupling unit 178 comprising an optical fiber 180 and an optional focusing optics 184 disposed or positioned to receive and to transport a laser beam λ either into free-space or to an optional downstream block or element 182 (shown in phantom). In an example, the downstream block or element 182 may comprise an external heat dissipation means or beam dump for dissipation of the energy contained in said laser beam λ. In another example, the downstream block or element 182 may comprise a downstream receiver, unit or element that is configured to process the laser beam λ received via the optical fiber 180. However, these examples are not to be construed in a limiting sense since it is envisioned that the downstream block or element 182 may comprise any suitable and/or desirable means that may interact with the laser beam λ in a desired manner.

In another example, any combination of a mirror and receiver described throughout this disclosure, such as, for example, the mirror 18 and the receiver 12 shown in any of the figures, may be replaced by the fiber coupling unit 178 comprising the optical fiber 180 and the optional focusing optics 184 disposed or positioned to receive and to transport the laser beam λ either into free-space or to the downstream block or element 182. In this example, the laser beam λ may be input directly into the optical fiber 180, via the optional focusing optics 184, if present, without first being reflected by the mirror 18.

As described above, the downstream block or element 182 may comprise an external heat dissipation means or beam dump for dissipation of the energy contained in said laser beam λ or a downstream receiver, unit or element that is configured to process the laser beam λ received via the optical fiber 180. However, these examples are not to be construed in a limiting sense since it is envisioned that the downstream block or element 182 may comprise any suitable and/or desirable means that may interact with the laser beam λ in a desired manner. Examples of the use of an optical fiber to remove a laser beam to a heat dissipation means or beam dump can be found in U.S. Pat. Nos. 7,385,752 and 7,469,091, the disclosures of which are incorporated herein by reference.

With reference to FIG. 12A, in one non-limiting embodiment or example in accordance with the principles of the present disclosure, each intensity modulator 26 described herein may comprise a modulation unit 190 disposed or positioned for receiving the λ1 laser beam from the laser source 4, for intensity modulating the received λ1 laser beam, and for outputting the intensity modulated λ1 laser beam to the first harmonic generator block or element 8. In an example, the modulation unit 190 may include, in the path of the λ1 laser beam from the laser source 4 to the first harmonic generator block or element 8, a first polarizer 192, a modulator 194, a λ/2 waveplate 196 and a second polarizer 198.

In operation of the intensity modulator 26, the first polarizer 192 polarizes the incoming λ1 laser beam in a first polarization direction and passes or transmits the polarized λ1 laser beam to the modulator 194 which intensity modulates the polarized λ1 laser beam in a manner known in the art. The intensity modulated λ1 laser beam is then output to the second polarizer 194 which polarizes the intensity modulated λ1 laser beam in the first polarization direction and outputs the intensity modulated λ1 laser beam to the first harmonic generator block or element 8. The first and second polarizers 192 and 198 may also transfer λ1 laser light not polarized in the first polarization direction to one or more optional beam dumps, e.g., beam dumps 200 and 202, for dissipation of the energy in said transferred λ1 laser light.

In an example, the modulator 194 may be an electro-optic modulator, such as a Pockels cell, which intensity modulates the λ1 laser beam in response to a signal or voltage of suitable and/or desirable amplitude and/or frequency being applied to the crystal comprising the modulator 194 from an external source of the said signal or voltage (not shown). In another example, the modulator 194 may be an acousto-optic modulator which intensity modulates the λ1 laser beam in response to an acoustic signal of suitable and/or desirable amplitude and/or frequency being applied to the crystal comprising the modulator 194 from an external source of the said acoustic signal (not shown).

With reference to FIG. 12B, another example intensity modulator 26 in accordance with the principles of the present disclosure is, with the following exception, similar to the intensity modulator 26 shown in FIG. 12A. The exception is the addition of mirrors 204, 206, 208, and 210 positioned as shown in FIG. 12B for accurately directing the incoming λ1 laser beam received from the laser source 4 to the modulation unit 190 and for accurately directing the intensity modulated λ1 laser beam output by the modulation unit 190 to the first harmonic generator block or element 8.

In operation, mirror 204 receives and reflects the incoming λ1 laser beam from the laser source 4 to mirror 206 which reflects the λ1 laser beam to the modulation unit 190 which intensity modulates the incoming λ1 laser beam in the manner described above in connection with FIG. 12A to produce and output the intensity modulated λ1 laser beam. The intensity modulated λ1 laser beam output by the modulation unit 190 is reflected by mirror 208 to mirror 210 which reflects the intensity modulated λ1 laser to the first harmonic generator block or element 8. The one or more optional beam dumps, e.g., beam dumps 200 and 202, may also operate in the manner described above in connection with FIG. 12A.

While not specifically shown, it is envisioned that one or more additional intensity modulators may also or alternatively be disposed or positioned to intensity modulate one or wavelengths of laser beams immediately prior to entry or input into one or more of the second, third and/or fourth harmonic generator block(s) or element(s) included in the various embodiment or example laser systems 2 described in this disclosure.

Throughout this disclosure, one, or more, or all or the collimating lens 20, the half (λ/2) waveplate 22, the intensity modulator 26 and the focusing lens 24 disclosed in the various examples may be optional. Also, each crystal described herein may include an anti-reflection (AR) coating on its optical surfaces. The AR coating on each crystal may be chosen for the wavelength(s) of the application of the crystal.

Although the disclosed laser systems have been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, that one or more of the disclosed features can be combined may be combined together in any suitable and/or desirable manner.

1. A laser system comprising:
a laser source outputting a first wavelength laser beam in the infrared spectrum; and
a first harmonic generator block or element including a first crystal disposed or positioned for receiving from the laser source the first wavelength laser beam and for outputting from the first crystal the first wavelength laser beam and a second wavelength laser beam, wherein,
the laser source comprises a laser generator for generating the first wavelength laser beam and a polarization maintaining optical fiber for conveying the first wavelength laser beam to the first crystal, having a linewidth greater than or equal 40 or 50 GHz.

2. The laser system of claim 1, wherein the first crystal is a lithium triborate (LBO) crystal.

3. The laser system of claim 1, further including a set of mirrors for outputting the first and second wavelength laser beams output by the first crystal on separate paths.

4. The laser system of claim 1, further including a second harmonic generator block or element including a second crystal disposed or positioned for receiving from the first crystal the second wavelength laser beam and for outputting from the second crystal the second wavelength laser beams and a third wavelength laser beam.

5. The laser system of claim 4, further including a first mirror for passing or transmitting the first wavelength laser beam output by the first crystal and for reflecting the second wavelength laser beam output by the first crystal to a second mirror which reflects the second wavelength laser beam to the second crystal.

6. The laser system of claim 4, wherein the second crystal is also disposed or positioned for receiving from the first crystal the first wavelength laser beam and for outputting from the second crystal the first wavelength laser beam.

7. The laser system of claim 6, further including at least one of the following:
the first harmonic generator block or element includes a first focusing lens in a path of the first wavelength laser beam before the first crystal; and
the second harmonic generator block or element includes a second focusing lens in a path of the first and second wavelength laser beams before the second crystal.

8. The laser system of claim 4, wherein at least one of the first crystal and the second crystal is a lithium triborate (LBO) crystal.

9. The laser system of claim 4, further including a third harmonic generator block or element including a third crystal disposed or positioned for receiving the second and third wavelength laser beams output from the second crystal and for outputting from the third crystal the second and third wavelength laser beams and a fourth wavelength laser beam.

10. The laser system of claim 9, wherein at least one of the following;
the first crystal is a lithium triborate (LBO) crystal;
the second crystal is a lithium triborate (LBO) crystal; and
the third crystal is a barium borate (BBO) crystal.

11. The laser system of claim 9, further including a prism disposed or positioned for receiving the second, third and fourth wavelength laser beams from the third crystal and for separating the second, third and fourth wavelength laser beams onto different paths.

12. The laser system of claim 9, further including:
a first set of mirrors disposed or positioned for passing or transmitting the first wavelength laser beam output by the second crystal and for directing the second wavelength laser beam from the second crystal to the third crystal along a first path; and
a second set of mirrors disposed or positioned for directing the third wavelength laser beam from the second crystal to the third crystal along a second path.

13. The laser system of claim 12, wherein the first and second sets of mirrors include at least one mirror in common.

14. The laser system of claim 12, wherein:
the first set of mirrors includes a first mirror disposed or positioned for receiving the first, the second and the third wavelength laser beams from the second crystal and for passing or transmitting the first and the second wavelength laser beams; a second mirror disposed or positioned for receiving the first and the second wavelength laser beams from the first mirror, for passing or transmitting the first wavelength laser beam and for reflecting the second wavelength laser beam to a third mirror which is disposed or positioned to reflect the second wavelength laser beam to a fourth mirror which passes or transmits the second wavelength laser beam to the third crystal; and
the second set of mirrors includes the first mirror reflecting the third wavelength laser beam to a fifth mirror which reflects the third wavelength laser beam to a sixth mirror which reflects the third wavelength laser beam to the fourth mirror which reflects the third wavelength laser beam to the third crystal.

15. The laser system of claim 14, further including one or more of the following:
a collimating lens in a path of the third wavelength laser beam between the first and fifth mirrors;
a cylindrical lens in a path of the third wavelength laser beam between the fifth and sixth mirrors;
a focusing lens in a path of the third wavelength laser beam between the fourth and sixth mirrors;
a collimating lens in a path of the first and second wavelength laser beams between the first and second mirrors; and
a focusing lens in a path of the second wavelength laser beam between the third and fourth mirrors.

16. The laser system of claim 4, further including a third harmonic generator block or element including a third crystal disposed or positioned for receiving the first wavelength laser beam output by the first crystal and the third wavelength laser beam output by the second crystal and for outputting from the third crystal the first and third wavelength laser beams and a fourth wavelength laser beam.

17. The laser system of claim 16, wherein at least one of the following;
the first crystal is a lithium triborate (LBO) crystal;
the second crystal is a barium borate (BBO) crystal or a cesium lithium borate (CLBO) crystal; and
the third crystal is a barium borate (BBO) crystal or a cesium lithium borate (CLBO) crystal.

18. The laser system of claim 16, further including a prism disposed or positioned for receiving the first, third and fourth wavelength laser beams from the third crystal and for separating the first, third and fourth wavelength laser beams onto different paths.

19. The laser system of claim 16, further including:
a first set of mirrors disposed or positioned for passing or transmitting the first wavelength laser beam output by the first crystal, for reflecting the second wavelength laser beam to the second crystal, for passing or transmitting the second wavelength laser beam output by the second crystal and for reflecting the third wavelength laser beam output by the second crystal; and
a second set of mirrors disposed or positioned for reflecting the first wavelength laser beam passed or transmitted by the first set of mirrors to the third crystal, and for reflecting the third wavelength laser beam reflected by the first set of mirrors to the third crystal.

20. The laser system of claim 19, wherein:
the first set of mirrors includes a first mirror for passing or transmitting the first wavelength laser beam and for reflecting the second wavelength laser beam to a second mirror which reflects the second wavelength laser beam to the second crystal which outputs the second and third wavelength laser beams to a third mirror which passes or transmits the second wavelength laser beam and which reflects the third wavelength laser beam; and
the second set of mirrors includes a fourth mirror for reflecting first wavelength laser beam passed or transmitted by the first mirror to a fifth mirror which passes or transmits the first wavelength laser beam to the third crystal and a sixth mirror for reflecting the third wavelength laser beam reflected by the third mirror to the fifth mirror which reflects the third wavelength laser beam to the third crystal.

21. The laser system of claim 20, further including one or more of the following:
a collimating lens in a path of the first wavelength laser beam between the first and fourth mirrors;
a collimating lens in a path of the second wavelength laser beam between the first and second mirrors;
a collimating lens in a path of the third wavelength laser beam between the third and sixth mirrors;
the sixth mirror includes a pair of sixth mirrors and a cylindrical lens in a path between the pair of a sixth mirrors;
a focusing lens in a path of the first wavelength laser beam between the fourth and fifth mirrors;
a focusing lens in a path of the third wavelength laser beam between the fifth and sixth mirrors; and
the fourth mirror includes a pair of fourth mirrors.

22. The laser system of claim 1, further including first and second receivers disposed or positioned to receive the first and second wavelength laser beams output by the first crystal.

23. The laser system of claim 4, further including first, second and third receivers disposed or positioned to receive the first, second and third wavelength laser beams output by the second crystal.

24. The laser system of claim 11, further including:
a first receiver disposed or positioned to receive the first wavelength laser beam output by the second crystal; and
second, third and fourth receivers disposed or positioned to receive the second, third and fourth wavelength laser beams output by the third crystal.

25. The laser system of claim 4, further including:
a first receiver disposed or positioned to receive the first wavelength laser beam output by the first crystal; and
second and third receivers disposed or positioned to receive the second and third wavelength laser beams output by the second crystal.

26. The laser system of claim 16, further including:
a first receiver disposed or positioned to receive the second wavelength laser beam output by the second crystal; and
second, third and fourth receivers disposed or positioned to receive the first, third and fourth wavelength laser beams output by the third crystal.

27. The laser system of claim 1, wherein the linewidth is between 40-300 GHz inclusive or between 40-120 GHz inclusive.

28. The laser system of claim 1, further including a first mirror disposed or positioned to receive the first and second wavelength laser beams output by the first crystal in a first, forward direction and to reflect the first and second wavelength laser beams back through the first crystal in a second, reverse direction, and a second mirror disposed or positioned to receive the first and second wavelength laser beams reflected back through the first crystal in the second, reverse direction, to pass or transmit the first wavelength laser beam and to reflect the second wavelength laser beam.

29. The laser system of claim 1, wherein the first harmonic generator block or element further includes a second crystal disposed or positioned for receiving the first and second wavelength laser beams output by the first crystal and frequency doubling the first wavelength laser beam received by the second crystal from the first crystal, thereby increasing an energy of the second wavelength laser beam received by the second crystal from the first crystal, and for outputting from the second crystal the first wavelength laser beam and the second, energy increased, wavelength laser beam, wherein the first and second crystals are disposed or positioned whereupon the first and second wavelength laser beams output by the first crystal travel or traverse a linear path or a zig-zag path between the laser source and an input face or side of the second crystal.

30. The laser system of claim 1, wherein the first harmonic generator block or element further includes one or more dispersion optics each configured to receive a separate instance of the first and second wavelength laser beams from the first crystal and to return said separate instance of the first and second wavelength laser beams to the first crystal.

31. The laser system of claim 4, wherein longitudinal axes of the first and second crystals are positioned at an angle to each other and a focusing optics is disposed or positioned between the first and second crystals to redirect or reflect the first and second wavelength laser beams output from the first crystal to an input face of the second crystal.

32. The laser system of claim 1, further including an intensity modulator disposed or positioned in a path of the first wavelength laser beam between the laser source and the first harmonic generator block or element, wherein the intensity modulator is operative or configured for intensity modulating the first wavelength laser beam received from the laser source and for providing the intensity modulated first wavelength laser beam to the first harmonic generator block or element.
